(19) United States
(12) Patent Application Publication
(10) Pub. No.: US 2009/0121121 A1
(43) Pub. Date: May 14, 2009

(54) Fibre Structure for the Identification of Defects In the Structure

(76) Inventors: Michael Dunleavy, Bristol (GB); Sajad Haq, Glasgow (GB)

Correspondence Address: JACOBSON HOLMAN PLLC, 400 SEVENTH STREET N.W., SUITE 600, WASHINGTON, DC, 20004, US

(21) Appl. No.: 11/988,060

(22) PCT Filed: Jun. 22, 2006
(86) PCT No.: PCT/GB2006/002322

§ 371 Date: Dec. 28, 2007

(30) Foreign Application Priority Data
Jun. 30, 2005 (GB) 0513496.0

(51) Int. Cl. G01J 5/08

(52) U.S. Cl. 250/227.14

(57) ABSTRACT

This invention is concerned with means for detecting potential fracturing, such as stress fractures, or damage to, a fibre based structure, by incorporating either hollow fibres containing coloured fluids, or solid fibres, or hollow fibres containing coloured fluids or fluids, which are capable of changing their visual appearance when exposed to external forces, and/or by incorporating fibres within the structure which can change a property such as electrical resistance, capacitance or inductance so that there is an indication whenever and wherever and the extent when a fracture occurs. Where coloured fluids are used, detection is by leakage of the fluid around the fracture. Where colour changing fluids are employed, detection is by observation of change of colour of the fluid. Different fluids can be used for different levels in the strata of tubes in the structure and where these are embedded within the structure, they can be observed where the fibres emanate from the body of the structure. Where fibres are incorporated into the structure that rely on electrical properties to sense a fracture, these fibres may be solid and formed from electrically conductive material and may be coated with such material. Alternatively, though used together with solid fibres, hollow fibres may be used where those hollow fibres contain and/or are coated with electrically conductive material. Appropriate detector means are associated with these fibres to detect the occurrence of a fracture.

### BACKGROUND

This invention is concerned with fibre materials and is specifically concerned with the use of fibres in the construction of fibre based structures to permit identification of defects in such structures. Fibre based structures are those in which fibres are embedded in a matrix, usually but not exclusively of a resin material, and those in which the fibres are arranged as by weaving, knitting, braiding, stitching and the like, to form a composite body.

The invention is specifically concerned with composite bodies which include hollow and/or solid fibres for the purpose of identifying defects such as fractures in such composite bodies. Where hollow fibres are deployed, such hollow fibres may be filled with solids or fluids, and may be coated, and it is to be clearly understood that where reference is made hereinafter to fluids being present or flowing into or from such hollow fibres, these fluids may be gaseous or liquid depending upon the application to which the hollow fibres are put, and that, where specific reference is made to use of liquids, it is to be understood that use of liquids is preferred but that gaseous fluids are not necessarily precluded.

### SUMMARY

In one aspect, the present invention provides a structure comprising a plurality of fibres arranged to form a composite body, the structure including means for identifying a fault in the structure, the means comprising a plurality of hollow and/or solid fibres within the body including one or more arrays of fibres having electromagnetic properties which can be changed due to fracture thereof, the properties being selected from the group consisting of photochromic, thermochromic, electrochromic, piezochromic, carsolchromic, and solvatechromic properties, electroluminescence, fluorescence, phosphorescence, sonoluminescence, photoluminescence, triboluminescence, and electrical parameters including resistance, capacitance and inductance.

The properties of the fibres are imparted by at least one of solid fibres which are formed of materials having said properties, and hollow fibres which are filled with or internally coated with materials having said properties.

The present invention also provides, in another aspect, a structure comprising a plurality of fibres arranged to form a composite body, the structure including means for identifying a fault in the structure, the means comprising a plurality of hollow fibres including one or more arrays of fibres within the body which are connectable to a source of a fluid that is selected from the group consisting of (a) photochromic, thermochromic, electrochromic, piezochromic, carsolchromic and solvatechromic fluids, a colour of which can change due to an external influence, (b) electroluminescent, fluorescent, phosphorescent, photoluminescent triboluminescent and sonoluminescent fluids, the property of which can change due to an external influence, and (c) coloured fluids, such that when the one or more arrays is/are filled with one or more of the selected fluids and (1), where a fluid whose colour/property can change due to an external influence is used, a change in colour of the selected fluid occurs, and (2), where a coloured fluid is used, a leakage of the fluid is detected, in the event of the existence of a fault in the structure.

(Where fluids are used, it may be possible to substitute hollow fibres filled with those fluids by hollow fibres filled with solid material or coated with such materials or solid fibres made from equivalent materials. In addition, where fluid-filled fibres are used, these fibres may be sealed once so filled depending upon the function that the structure in which they are incorporated is to serve.) The hollow fibres may be supplied from reservoirs of fluid and those reservoirs may be external to the structure or may be provided by other hollow fibres within the structure.

Preferably, the structure is formed of fibres embedded in a matrix material which may, inter alia, be a hardened resin material such as an epoxy resin, or an elastomeric material depending upon the function to be served by the structure. For example, the structure may be a panel of the skin of an aircraft, or a vehicle body part, a panel of a waterborne craft (which may be a surface vessel or a submarine vessel) or a part of a building unit in which case the structure will be formed as a matrix of resin material in which the fibres are embedded. On the other hand, where the fibres are used in a structure such as a fabric, where flexibility is required, the fibres can be assembled together by weaving, knitting, braiding, stitching etc. without the use of resin material.

The fluids used may be, as stated above, liquids or gases according to which is most suitable. For example, where the fluid is a liquid, the fluid may also be a colloid comprising a carrier liquid carrying particles selected to produce the desired effect or may be a gas carrying such particles, or may be either where such particles are intended to condense on inner surfaces of a hollow fibre.

Fibres of said one or more arrays may be adjacent or at the surface of the structure so as to be visible from the exterior of the structure, though, depending upon the thickness of the structure, at least one array of fibres will be embedded within the structure. Where any such fibres are embedded in a structure having any substantial thickness compared with the size of the fibres themselves, such fibres of the at least one array can extend externally of the structure so that portions of such fibres are visible or can be connected to detector means for detecting any change in the property associated with those fibres.

Where the fibres are, or each array of fibres is, hollow and contains a fluid of the group consisting of photochromic, thermochromic, electrochromic, piezochromic, carsolchromic and solvatechromic fluids, such fibres will be connected with colour change detector means adapted to sense colour change in the event of a fault occurring in the structure. As mentioned above, solid fibres having the same properties can also be used in a structure according to the present invention as an alternative or in addition to hollow fibres having those properties. Furthermore, where a structure according to the present invention includes at least one array of fibres comprising fibres which contain a material, fluid or solid or coated onto the interior of the fibre, of the group consisting of electroluminescent, fluorescent, phosphorescent, photoluminescent, sonoluminescent and triboluminescent fluids, those fibres will also be connected with optical detector means adapted to sense emission of light in the event of a fault occurring in the structure.

Whether or not the fibres are hollow or solid, the one or more arrays of fibres will ideally be arranged in different regions of the structure, and where the fibres are hollow, each array can have an associated source of fluid whereby each array can indicate a fault in its region which indication presents a colour change that is different from that of adjacent regions of the structure. The one or more arrays of fibres may be arranged in layered strata which are arranged in layered horizontal or substantially horizontal strata. The one or more arrays of fibres may also include fibres arranged in vertical or substantially vertical strata.

Within a structure according to the present invention, a set of solid fibres can also be provided, formed of a material selected from the group consisting of photochromic, thermochromic, electrochromic, piezochromic, carsolchromic, solvatechromic, electroluminescent, fluorescent, phosphorescent and photoluminescent materials, where the fibres of the set are arranged adjacent the fibres of the first array such that they can detect and indicate any change in the fibres of the first array.

The present invention also provides a structure comprising a plurality of fibres arranged to form a composite body, the structure including means for identifying a fault in the structure, the means comprising a plurality of hollow and/or solid fibres including one or more arrays of fibres having electrical properties which can be changed due to fracture thereof, the fibres being formed from or containing or being coated with a material having said properties, and means connected to the fibres for monitoring the properties.

Said material may, for example, be a piezoelectric material.

The present invention also provides a process of testing the structure of a body panel of a mobile land-, air- or water-based vehicle for the effect of external forces, such as stresses and strains, acting thereon, the structure thereof having incorporated therein a plurality of hollow fibres arranged in one or more arrays, each array of fibres being connectable to a source of a fluid that is selected from the group consisting of electroluminescent, fluorescent, phosphorescent, photoluminescent, sonoluminescent, triboluminescent, photochromic, thermochromic, electrochromic, piezochromic, carsolchromic and solvatechromic fluids, the method comprising filling the fibres with such fluid(s) as required, subjecting the body to stress and/or strain under static conditions, monitoring the effect on fluid present in the fibres, and thereafter subjecting the body to external forces in operation of the vehicle and monitoring the effect thereof on fluid in the fibres under such operational conditions.

The fluids used in the fibres may be such that by chemical reaction or evaporation can create coatings on the inside surfaces of the fibres.

The present invention also provides a process of testing the structure of a body panel of a mobile land-, air- or water-based vehicle for the effect of external forces, such as stresses and strains, acting thereon, the structure thereof having incorporated therein a plurality of fibres arranged in one or more arrays, each array of fibres being formed of a material selected from the group consisting of electroluminescent, fluorescent, phosphorescent, photoluminescent, sonoluminescent, triboluminescent, photochromic, thermochromic, electrochromic, piezochromic, carsolchromic and solvatechromic materials, subjecting the body to stress and/or strain under static conditions, monitoring the effect on the fibres, and thereafter subjecting the body to external forces in operation of the vehicle and monitoring the effect thereof on the fibres under such operational conditions.

A further approach to the identification of defects or damage in a structure such as the skin of an aircraft is also foreseen by the present invention.

Accordingly, the present invention further provides a structure comprising a body which is at least partially formed of hollow fibres which are assembled in a material matrix (which may be a cured adhesive material or an elastomeric material for example), the fibres comprising groups of hollow fibres, each of which comprises at least one fibre carrying one or more X-ray absorbent dye compositions.

As with other embodiments of the present invention, the at least one fibre may be a hollow carbon fibre, a fibre formed of a polymeric material or of glass.

The absorbent dye composition may comprise a electroluminescent, fluorescent material, such as for example, a dye selected from fluorescein, rhodamines, cumarins, in solution and may be deposited as a coating on the interior surfaces of the fibres.

Each group of fibres may comprise at least one pair of fibres which are arranged in juxtaposed relationship to each fibre carrying the one or more X-ray penetrant or X-ray absorbent dyes, one fibre of each of the at least one pair of fibres carrying one part of a two-part curable resinous composition and the other of which pair carrying a second part thereof, whereby, in the event of fracture occurring to the group of fibres as detected by an external X-ray sensing device, the two parts of the composition can leak from their respective fibres in the region of such fracture and seal it.

### DETAILED DESCRIPTION OF SPECIFIC EMBODIMENTS

There now follows a detailed description which is to be read with reference to the accompanying drawings of embodiments of the present invention that have been selected for description to illustrate the invention by way of example and not by way of limitation.

In the drawings:—

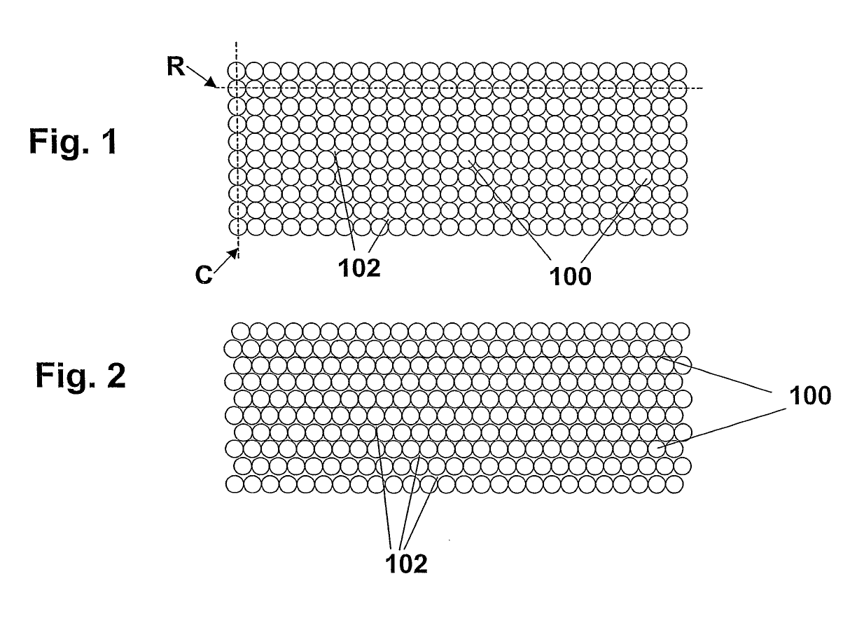

FIG. 1 is a diagrammatic illustration of a matrix of fibres and resin as used in a structure according to the present invention which may provide a panel of the skin of an aircraft;

FIG. 2 is a diagrammatic illustration similar to that of FIG. 1 showing an alternative configuration of fibres in a matrix of fibres and resin;

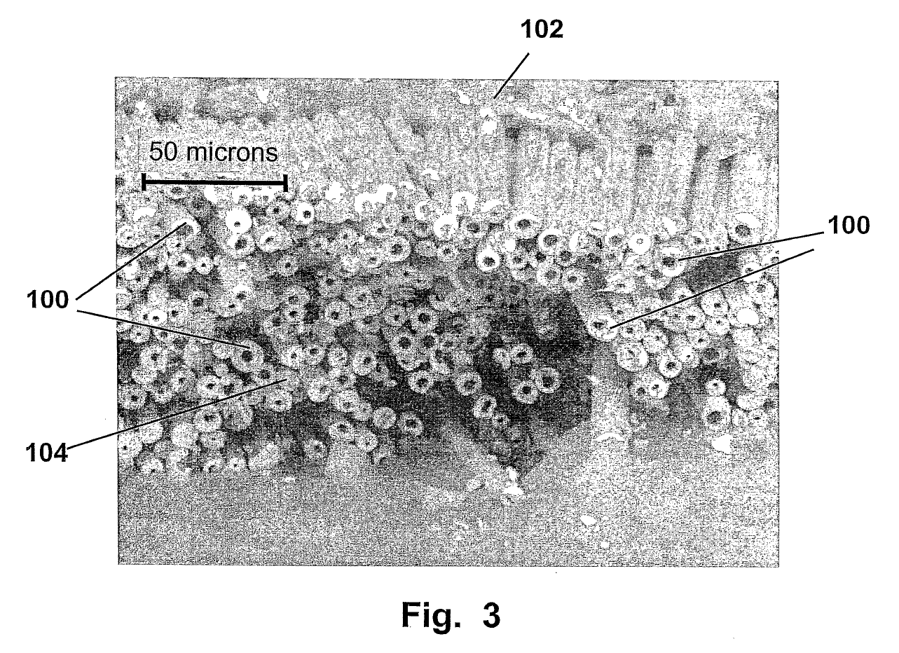

FIG. 3 is an enlarged photograph of a resin and fibre matrix;

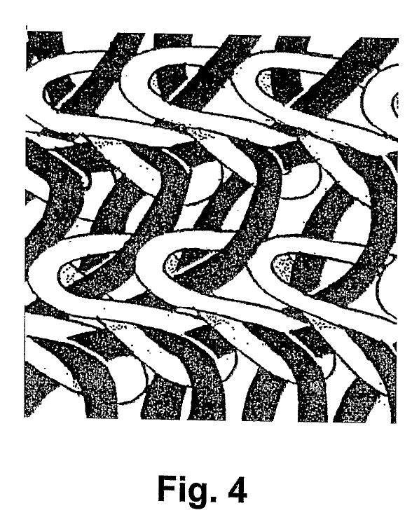

FIG. 4 is a diagrammatic illustration of one method of securing fibres together in the matrix;

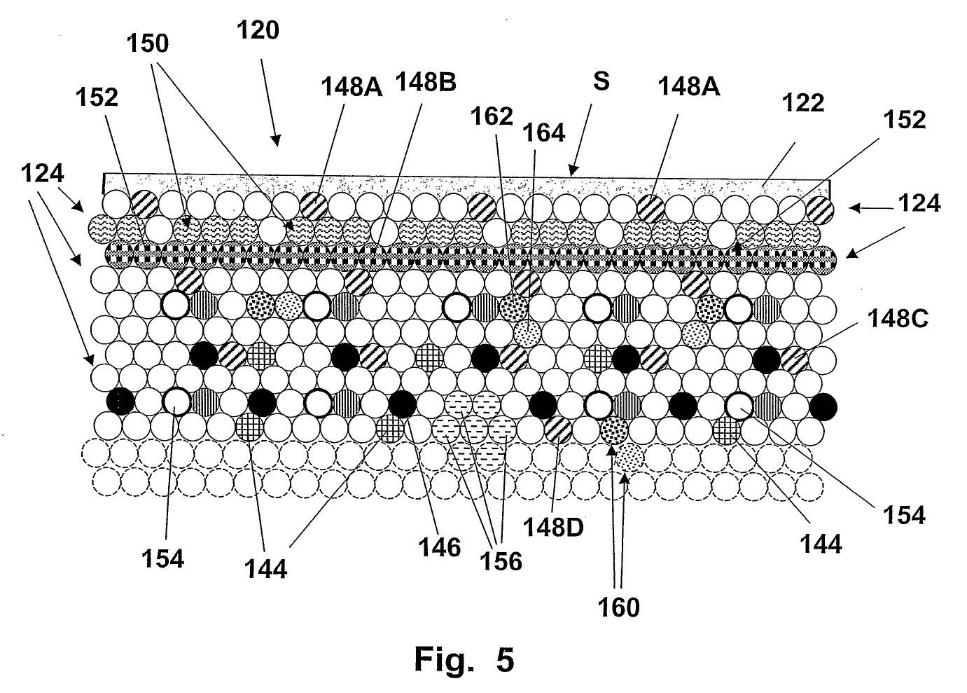

FIG. 5 is an illustration similar to that of FIG. 1, indicating a functional arrangement of fibres within a matrix of a structure according to the present invention; and

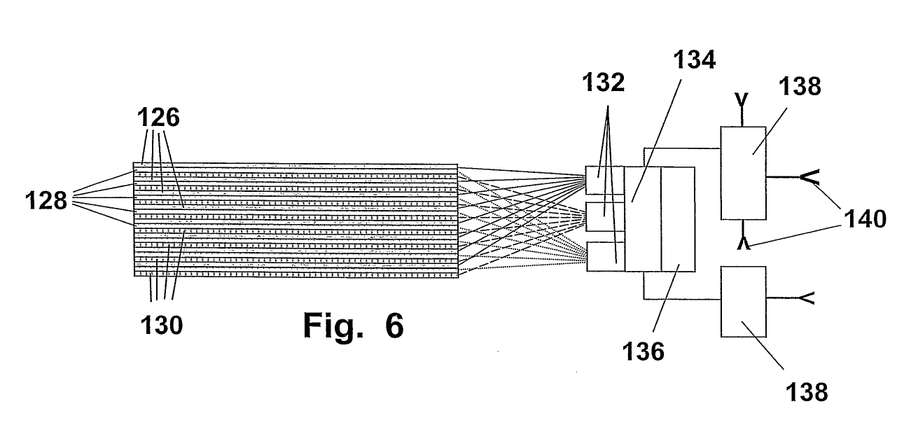

FIG. 6 is a diagrammatic illustration showing the manner in which arrays of fibre can be connected to a fluid pressurising means of one embodiment of the invention; and

Referring to FIG. 1, there is shown therein, in exaggerated form, a section of a group of fibres 100 of a structure according to the present invention in the form of a panel of the skin of an aircraft. Each of the fibres is a fibre having an external diameter in the range of about 10 microns to about 12 microns, although as is hereinafter described, some fibres may be incorporated into the structure and may have external diameters up to about 100 microns, in addition to fibres that may be incorporated into the structure for the purpose of providing greater strength and rigidity to the structure.

Depending upon the function that they are to perform in the structure, the fibres 100 may comprise entirely hollow fibres some or all of the fibres may be hollow though it is preferred that some may be solid, and depending upon the same function, the fibres may be formed from any suitable material, most notably carbon fibre material, glass fibre material or one or more suitable polymeric materials.

Where hollow fibres are employed, they have, preferably, internal diameters in the range of about 5 to about 7 microns, while, where larger fibres having external diameters up to about 100 microns are required, and these are also hollow, they will have internal diameters in the range of up to about 70 microns.

As will be appreciated from the above quoted dimensions, the section of each of the structures shown in FIGS. 1 and 2 which comprises smaller fibres (i.e. having external diameters of about 10 microns) has a thickness of about 100-120 microns whereas in an aircraft skin panel a typical thickness would be of the order of ten such sections per millimetre of thickness of the panel.

The manner in which a structure according to the present invention is assembled is described generally in our co-pending UK patent application No. 0503740.3. Though shown in an arrangement in FIG. 1 in which the fibres are arranged in linear columns C and rows R, it will be readily appreciated by those skilled in the art that the arrangement of fibres 100 may be more random than as illustrated and that there will be a spacing between adjacent fibres which is filled by a curable resinous material 102, such as an epoxy resinous material, to form a body in which the fibres are embedded in the resin matrix. However, it is important that the fibre volume fraction is in the range of about 60%-65%

In FIG. 2 is shown an arrangement of fibres 100 embedded in its matrix of resinous material 102 which is more akin to how the fibres may be embedded in practice when they are compressed together, though this is an idealised arrangement and would probably have less of a degree of uniformity than is shown in the Figure and a lower fibre volume fraction.

A typical arrangement of fibres assembled in a test arrangement is shown in the enlarged photographic image shown in FIG. 3 wherein the ends of the fibres can be seen extending from the matrix. The fibres extend from the matrix so that they can be coupled to devices as hereinafter described. This arrangement was used by the applicants to test some of the potential applications of the present invention and can be seen to consist almost entirely of hollow fibres. In actual practice, other fibres would be included in the matrix, including solid fibres, one of which, is shown at 104, for the purpose hereinafter described.

The manner in which the fibres are set into the resinous material can be varied also. Bundles of fibres may be laid into the resin but, alternatively, where a more ordered arrangement is required, they can be laid down into the resinous material in layers of the type referred to above and then be successively covered over by application of further resin until the desired thickness is reached. The resin can be sprayed onto the top of the layers already laid down or applied in any other suitable manner.

Fibres may be laid down so that they are arranged in discrete layers until a desired thickness is attained.

Depending upon the desired characteristics of the structure made from the fibre/resin matrix, the fibres can be laid down in the formation of the matrix in a number of different ways. As alternatives to the arrangements shown in FIGS. 1 and 2, wherein the fibres are laid down in substantially parallel relationship to one another in the resin, they may be initially woven together or knitted, together in any number of different weaves or patterns depending upon the requirements of the final structure. Alternatively, they may be laid down in layers which are arranged transversely to one another at any desired angle, with or without woven or knitted layers in between. An example of an interwoven arrangement of fibres is shown in FIG. 4.

In one embodiment of the present invention, the application of these techniques is illustrated as applied to a structure in the form of a panel of an aircraft. This is shown in FIG. 5. As can be seen in FIG. 5, which shows an upper portion of such a panel close to its surface S where, for convenience, the fibres are shown as layers 124. The panel structure, which is generally indicated at 120, has thereon a layer of a transparent lacquer paint 122 which overlies the structure 120 itself. The character and nature of the paint is not essential to further understanding of the present invention and will therefore not be further described.

Below the layer of transparent paint, the structure comprises the series of layers 124 of hollow fibres. Arrays of these fibres in accordance with a preferred embodiment of the present invention are connected to reservoirs of fluids as shown in FIG. 6. In the example shown in FIGS. 5 and 6, these fluids are simply coloured fluids. The fibres are shown in FIG. 6 as arranged in three groups 126, 128 and 130. The coloured fluids in the hollow fibres are filled with liquids that are coloured according to the part of the structure in which the fibres are located. As will be explained below, other fluids and materials are also envisaged.

The means for pressurising liquids in the fibres and for filling and emptying and replacing the liquids therein is provided by valve units 132 that can either be specific to each group of fibres or can be specific to each coloured liquid, or both. As shown in FIG. 6, such valve units are shown as connected to the specific groups of fibres. The means further comprises a plurality of pumps 134 (which may alternatively be any appropriate form of hydraulic or pneumatic system for pressurising the liquid content of the fibres) which can deliver liquid from reservoirs 136 of the liquids to the fibres under control of sensor devices 138 that are adapted to sense a change in the conditions under which the liquids are delivered to the fibres, such a change of pressure in a fibre when the fibre is fractured. In addition to the fluid reservoirs storing the liquids, additional reservoirs (not shown) can be provided for diluting the liquids to dilute the intensity of colour thereof. The liquids used may be waterbased colouring agents or alternatively other dyestuffs may be used in any liquid carrier, such as solvent based dyes. In addition, provision may be made for the addition of electroluminescent and/or fluorescent brighteners to increase colour brightness.

As shown in FIG. 6, the sensor devices 138, particularly for a structure such as may be fitted to an aircraft, can include transmission means 140 which permit the condition of a structure to be notified to a ground station or, via a satellite communication system, to such a ground station.

Referring now to FIG. 5, arrangements for identifying a defect in a unitary structure are hereinafter described. The drawing in FIG. 5 illustrates a portion of a structure that is a panel of an aircraft skin. It will however be appreciated by the man skilled in the art that the invention is equally applicable to other structures such as a panel of a land vehicle or of a waterborne craft.

This aspect of the invention is based upon the use of fluids and solid materials, including coatings, that can respond to external stimuli and so change colour and thus can be used for the purpose of detecting a defect such as a fracture in a structure of which fibres containing those fluids or solid materials form a part. A defect may occur for a number of different reasons, namely an inherent weakness in the fabric of the structure, subjection of the structure to undue stresses or strains, or impact of a structure such as a projectile or a bird against the structure. Referring to FIG. 5, the structure is formed of or includes a plurality of hollow fibres arranged in a plurality of arrays 144, 146 and 148 as described previously. The fibres of the array 148 for example include fibres 148A, 148B, 148C, 148D specifically connected to one or more sources of liquid that are selected from the group consisting of photochromic, thermochromic, electrochromic, piezochromic, carsolchromic and solvatechromic fluids, a colour and other properties of which can change due to an external influence such as the creation of a fracture therein. Though these fibres are set, in the layers 124, amongst other fibres whose functions are different and may include for example fibres 150, 152 whose function is to provide camouflage where necessary (as disclosed in our co-pending UK patent application no. ______) and fibres 154 arranged singly or in pairs 160 to deliver one-part and two-part adhesive compositions respectively to close a fracture where it occurs (as disclosed in our co-pending UK patent applications nos. ______ and ______), these specific fibres 148 are connected to sources of liquid that are of a distinctive colour as compared with the liquids in the other fibres in those layers. As can be seen from FIG. 5, one array of fibres 148A is adjacent the surface of the structure in the uppermost layer of fibres while the other arrays 148B, 148C 148D of fibres are arranged in layers or strata lying below the surface so that the fibres of those arrays are embedded in the structure itself. The spacing of the fibres of each of the arrays is shown as being at substantially regular intervals throughout the structure. In the illustrated example, with hollow fibres having a maximum external diameter of about 10 microns, it can be seen that the lateral spacing of fibres of the arrays 148A-148D is approximately 40-50 microns. In practice it may be possible to distribute these fibres with a greater spacing between them as a fracture is most likely to involve a large number of fibres in any one region of the structure. Similarly, the vertical spacing between the adjacent arrays of fibres 148A-148D is shown as 20 microns though this too can be varied.

The spacing of the arrays 148A-148D and of the fibres thereof must be such that, in the event of a structural defect occurring to the structure at any point along its length or through its depth, which will result in fracture of the fibres of the structure, one or more of the fibres of the arrays 148A-148D will also fracture, allowing liquid to leak from the fibres containing those fluids. Because the liquids themselves will respond to that fracture, they will change colour and that colour change will be visible to a maintenance engineer at the surface of the structure for those fibres which are close to the surface and also at the edge of the structure for those fibres which are embedded deeper within the structure.

In addition, the structure, though not illustrated, can include similar fibres that are arrayed at spaced intervals and extend vertically through the structure, by for example Z-pinning.

The different arrays of fibres are ideally filled with liquids having different colour change properties so that the region in which any defect occurs can be readily identified. For the purposes of inspection, visual identification may be sufficient. However, it will be important to be able to identify a defect that could ultimately be disabling, where for example, the defect occurs where that region of the structure is inaccessible. To this end, the fibres of the arrays 148A-148D of the structure are connected with colour change detector means adapted to sense colour change in the event of a fault occurring in the structure.

This is particularly important where the structure is subjected to stress or strain while in use, as for example in an inflight aircraft. The detector means can then provide warning in a head-up display for the pilot of the aircraft of very small defects in the structure of a panel of the aircraft skin before they develop into major structural faults. Our aforementioned co-pending UK patent applications address the manner in which repair of damage such as a fracture may be effected using one- and multi-part adhesives.

As an alternative to the use of photochromic, thermochromic, electrochromic, piezochromic, carsolchromic and solvatechromic fluids, or as an additional measure to their deployment, the invention proposes the use of fluids, particularly liquids selected from the group consisting of luminescent, electroluminescent, fluorescent, phosphorescent, sonoluminescent, photoluminescent, sonoluminescent and triboluminescent fluids, the property of which, namely the ability to emit light, can change due to an external influence. These liquids can be used instead of the different chromic liquids or can be used together with those liquids in separate arrays of fibres.

As a further embodiment of the present invention, solid fibres can be included in the structure either in place of or together with the hollow fibres containing the luminescent or chromic liquids and/or coatings of such materials. Such solid fibres can be made of solid luminescent or chromic materials. These solid fibres can be incorporated into the structure in a similar manner to the hollow fibres containing liquid luminescent or chromic materials and be coupled to sensors for detecting change in colour to indicate the presence of a defect in the structure.

In addition, adjacent the surface of the structure, a further array of hollow fibres may be provided which contain and are connectable to a source of a coloured fluid. The purpose of the coloured liquid is simply to provide superficial evidence of the existence of a defect such as a crack at or adjacent the surface of the structure. Ideally, the liquid is of a type that will harden on exposure to air.

In a further embodiment of the present invention, solid fibres which are electrically conductive can be deployed in a structure according to the present invention in conjunction with sensors/detectors which can detect a change in an electrical property such as resistance, capacitance or inductance due to a fracture of that fibre. Such solid fibres may themselves be electrically conductive or have an electrically conductive coating thereon. Together with or as a substitute for solid fibres, hollow fibres having an internal and/or external electrically conductive coating may also be used, or the hollow fibre may simply be filled with an electrically conductive filler or fluid.

Other fibres such as carbon fibres such as are shown at 156 may be arranged in twisted form to provide additional strength to the structure.

In the drawings, it will be appreciated that only a limited depth of fibre layers is illustrated and that in a structure such as an aircraft wing panel, which may be have a thickness of at least 2.5 centimetres, there may be as many as 250 such layers. Together with the arrays of fibres providing an indication of the condition of the structure, additional arrays of hollow or solid fibres can also serve a further purpose which is to monitor the condition of those, adjacent, fibres. To this end, a plurality of fibres can be arranged in one or more further arrays at least one of which includes a first set of fibres selected from the group consisting of solid fibres having a visibly changeable property and hollow fibres filled with a fluid having a visibly changeable property, the property being provided by photochromic, thermochromic, electrochromic, piezochromic, carsolchromic, solvatechromic, electroluminescent, fluorescent, phosphorescent, sonoluminescent, photoluminescent, sonoluminescent and triboluminescent materials, and a second set of fibres selected from said group, the fibres of one of the two sets being such that they can detect any change in the fibres of the other set.

It will be appreciated that the present invention can be applied to panels of aircraft skins, as has already been described above. Testing of these panels can be undertaken while the aircraft is parked, while the aircraft is under test on the ground and while the aircraft is flying.

However, the invention can also be applied to monitoring and testing the structure of a body of any mobile vehicle or surface craft, where the structure thereof has incorporated therein a plurality of hollow fibres arranged as described above.

Though not illustrated in the drawings, the present invention can also be used for providing a structure comprising a body which is at least partially formed of hollow fibres arranged in groups of hollow fibres, each of which comprises at least one fibre carrying one or more X-ray absorbent dye compositions. As with the previous forms of the invention, the fibres containing the absorbent dye may be formed of carbon fibre, polymeric material and/or glass, diamond or boron and the absorbent dye composition may itself comprise a electroluminescent, fluorescent material. Preferred absorbent dyes are selected from fluorescein, rhodamines, cumarins, in solution or as coatings on interior surfaces of the fibres. The groups of hollow fibres containing the absorbent dyes are integrated into the fibre/resin matrix as this is formed and can be arranged in arrays with other fibres of the structure.

The fibres containing the absorbent dyes may be coated internally or externally or both.

Use of absorbent dyes can assist with the identification of sub-surface defects which may occur within the depth of the structure.

This aspect of the present invention has been described with reference to layers of fibres as shown in FIGS. 1, 2 and 5. However it will be readily appreciated that these layers may be arranged so that arrays of fibres descend or ascend depthwise through a structure and may even be arranged to extend vertically through a structure so that the fibres can be zoned widthwise across a structure so that there is repetition of the fibre assembly across the width of the structure.

The present invention can, as has been mentioned previously, be used to provide structures in the form of fabrics. Although the term structure would not normally be applicable to fabrics, the fibres that are employed in the present invention are so fine that large numbers of fibres would be required to construct a fabric therefrom of comparable thickness to known fabrics such as wool, cotton, silk and known synthetic fabrics. The term structure is therefore appropriate. Fabric structures according to the present invention may find particular utility in the manufacture, for example, of parachutes, sails and the like, especially when used in conjunction with self repair systems such as are disclosed in our aforementioned UK patent applications. Indeed, the hollow fibres as used in the present invention may be included in fabric structures which are formed from known fibre materials such as wool, cotton, silk and the like.

1-21. (canceled)

22: A structure comprising a plurality of hollow fibres arranged to form a composite body, the structure including means for identifying a fault in the structure, the means comprising a plurality of hollow fibres including one or more arrays of fibres having electromagnetic properties which can be changed due to fracture thereof, the properties being selected from the group consisting of photochromic, thermochromic, electrochromic, piezochromic, carsolchromic, and solvatechromic properties, electroluminescence, fluorescence, phosphorescence, photoluminescence, sonoluminescence, triboluminescence, and electrical parameters including resistance, capacitance and inductance.

23: A structure according to claim 22 wherein the properties of the fibres are imparted by hollow fibres which are filled with or internally coated with materials having said properties.

24: A structure according to claim 22 wherein fibres of said one or more arrays are adjacent or at the surface of the structure so as to be visible from the exterior of the structure.

25: structure according to claim 22 wherein at least one array of fibres is embedded within the structure.

26: A structure according to claim 25 wherein fibres of the at least one array extend externally of the structure so that portions of such fibres are visible.

27: A structure according to claim 22 wherein the or each array of fibres contains a fluid of the group consisting of photochromic, thermochromic, electrochromic, piezochromic, carsolchromic and solvatechromic fluids and is connected with colour change detector means adapted to sense colour change in the event of a fault occurring in the structure.

28: A structure according to claim 22 wherein the or each array of fibres contains a fluid of the group consisting of electroluminescent, fluorescent, phosphorescent, photoluminescent, sonoluminescent and triboluminescent fluids and is connected with optical detector means adapted to sense emission of light in the event of a fault occurring in the structure.

29: A structure according to claim 22 wherein the one or more arrays of fibres comprise hollow fibres arranged in different regions of the structure and each array has an associated source of fluid whereby each array can indicate a fault in its region which indication presents a colour change that is different from that of adjacent regions of the structure.

30: A structure according to claim 29 wherein the one or more arrays of fibres are arranged in layered strata.

31: A structure according to claim 22 wherein each array has an associated detector means whereby each array can indicate a fault in its region which presents a change in its associated electromagnetic property that is different from that of adjacent regions of the structure.

32: A structure comprising a body which is formed of hollow fibres which are assembled in a resin matrix, the fibres comprising groups of hollow fibres, each of which comprises at least one fibre carrying one or more X-ray absorbent dye compositions.

33: A structure according to claim 32 wherein the at least one fibre is formed of one of carbon fibre, polymeric material (e.g. a polymer such as polyacrylontrile), glass, diamond and boron.

34: A structure according to claim 32 wherein the penetrant/absorbent dye composition comprises a electroluminescent, fluorescent material selected from the group consisting of fluorescein, rhodamines and cumarins.

35: A structure according to claim 32 wherein each group of fibres comprises fibres arranged in juxtaposed relationship to each fibre carrying the one or more X-ray absorbent dyes, and carrying a curable resinous composition, whereby, in the event of fracture occurring to the group of fibres as detected by an external X-ray sensing device, the composition can leak from the respective fibres in the region of such fracture and seal it.

36: A process of testing the structure of a body panel of a mobile land-, air- or water-based vehicle for the effect of external forces, such as stresses and strains, acting thereon, the structure thereof having incorporated therein a plurality of hollow fibres arranged in one or more arrays, each array of fibres being connectable to a source of a fluid that is selected from the group consisting of electroluminescent, fluorescent, phosphorescent, photoluminescent, sonoluminescent, triboluminescent, photochromic, thermochromic, electrochromic, piezochromic, carsolchromic and solvatechromic fluids, the method comprising filling the fibres with such fluid(s) as required, subjecting the body to stress and/or strain under static conditions, monitoring the effect on fluid present in the fibres, and thereafter subjecting the body to external forces in operation of the vehicle and monitoring the effect thereof on fluid in the fibres under such operational conditions.
